(19) United States
(12) Patent Application Publication
(10) Pub. No.: US 2017/0111960 A1
(43) Pub. Date: Apr. 20, 2017

(54) VEHICLE COVERING AND WARMING SYSTEM

(71) Applicant: Sahar Arafa, Chicago, IL (US)

(72) Inventor: Sahar Arafa, Chicago, IL (US)

(21) Appl. No.: 14/887,889

(22) Filed: Oct. 20, 2015

(51) Int. Cl. H05B 3/36; H05B 1/02; H05B 3/38

(52) U.S. Cl. CPC H05B 3/36; H05B 3/38; H05B 1/0236

(57) ABSTRACT

A vehicle covering and warming system includes a panel that is flexible and has a top side, a bottom side and a perimeter edge. The perimeter edge includes a first end edge, a second end edge, a first lateral edge and a second lateral edge. The panel is positionable on a vehicle. A heating element is positioned within the panel between the top and bottom sides and warms the panel when the heating element is powered. A power supply is electrically coupled to the heating element. A control is in communication with the heating element to remotely and wirelessly turn the heating element on or off. The panel has four corners and a plurality of straps is attached to the panel. Each of the corners has one of the straps positioned adjacent thereto. The straps each include a magnetic material.

### BACKGROUND OF THE DISCLOSURE

### Field of the Disclosure

The disclosure relates to car cover devices and more particularly pertains to a new car cover device for removing snow and ice from a vehicle.

### SUMMARY OF THE DISCLOSURE

An embodiment of the disclosure meets the needs presented above by generally comprising a panel that is flexible and has a top side, a bottom side and a perimeter edge. The perimeter edge includes a first end edge, a second end edge, a first lateral edge and a second lateral edge. The panel is positionable on a vehicle. A heating element is positioned within the panel between the top and bottom sides and warms the panel when the heating element is powered. A power supply is electrically coupled to the heating element. A control is in communication with the heating element to remotely and wirelessly turn the heating element on or off. The panel has four corners and a plurality of straps is attached to the panel. Each of the corners has one of the straps positioned adjacent thereto. The straps each include a magnetic material.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective in-use view of a vehicle covering and warming system according to an embodiment of the disclosure.

FIG. 2 is a top view of an embodiment of the disclosure.

FIG. 3 is a bottom view of an embodiment of the disclosure.

FIG. 4 is a cross-sectional view of an embodiment of the disclosure taken along line 4-4 of FIG. 3

FIG. 5 is a bottom in-use view of an embodiment of the disclosure.

FIG. 6 is an electronic schematic view of an embodiment of the disclosure.

### DESCRIPTION OF THE PREFERRED EMBODIMENT

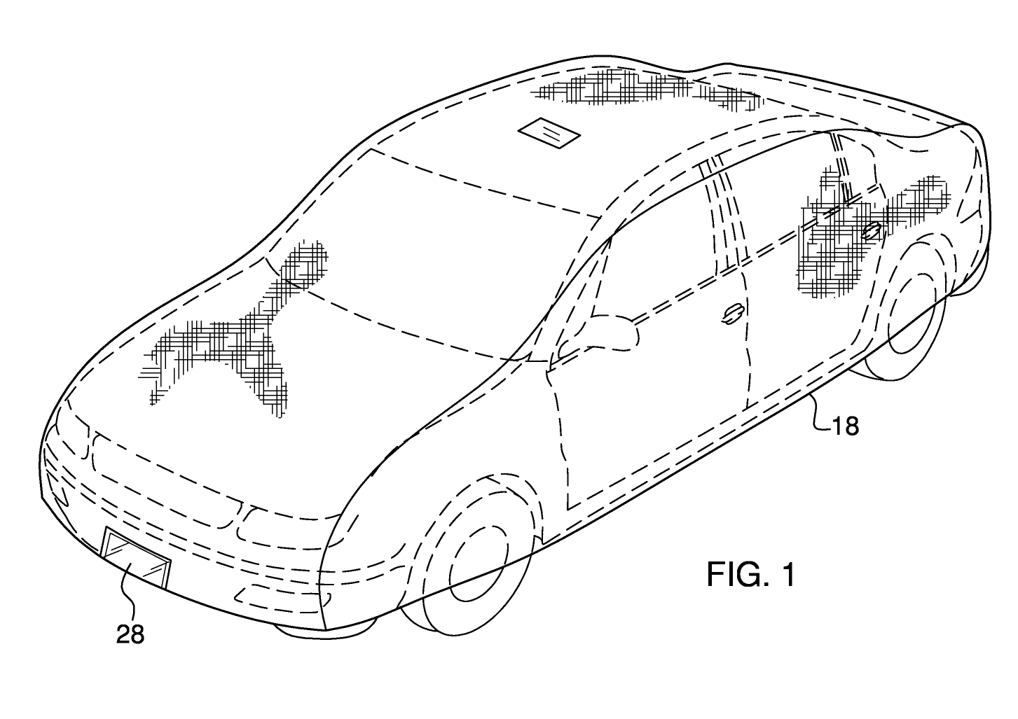

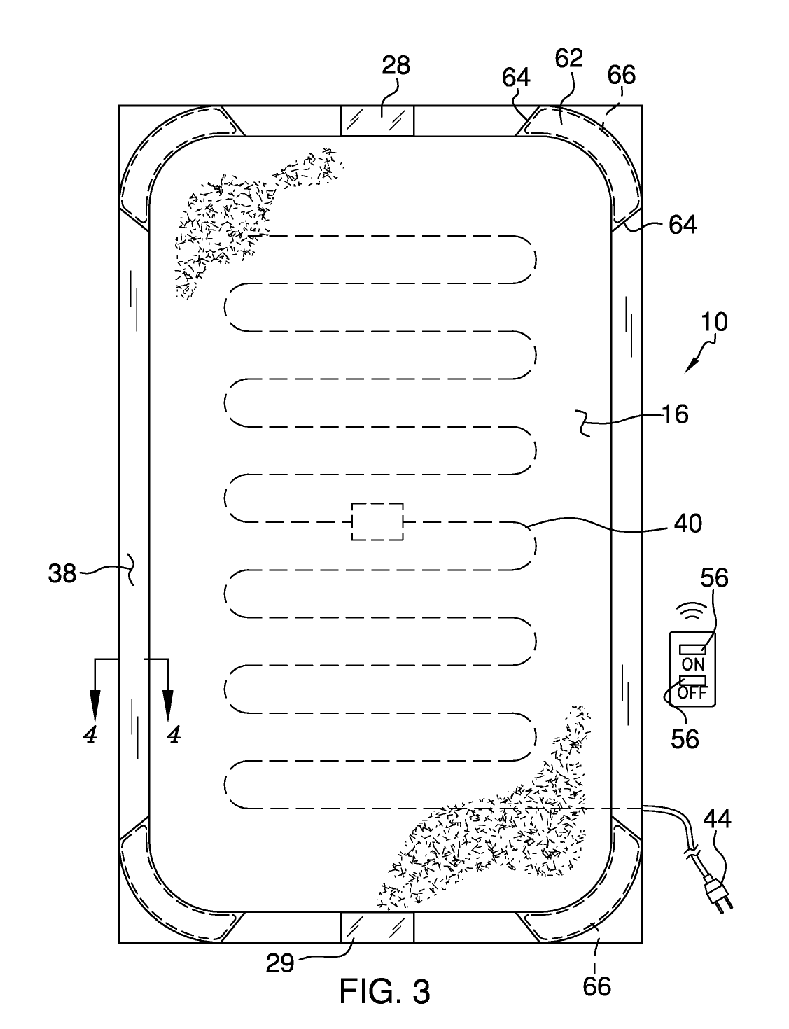

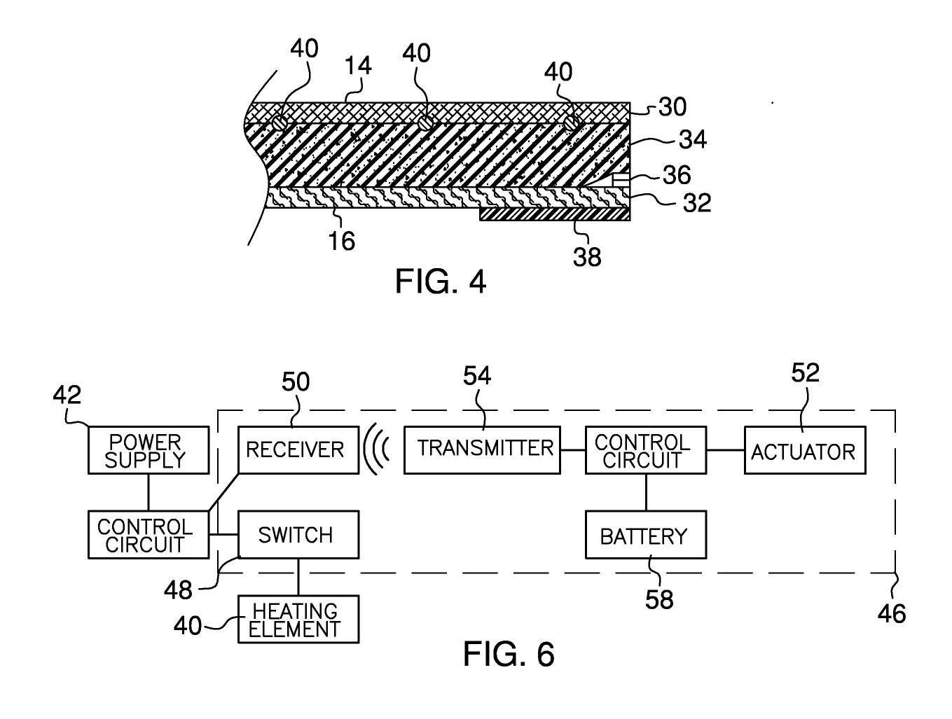

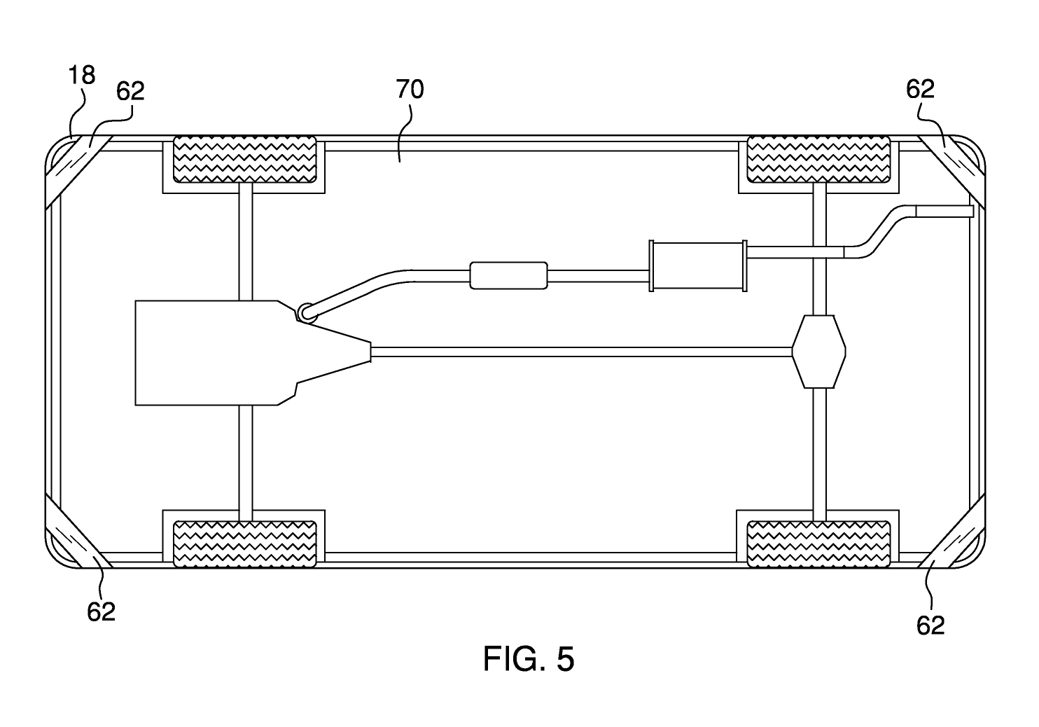

With reference now to the drawings, and in particular to FIGS. 1 through 6 thereof, a new car cover device embodying the principles and concepts of an embodiment of the disclosure and generally designated by the reference numeral 10 will be described.

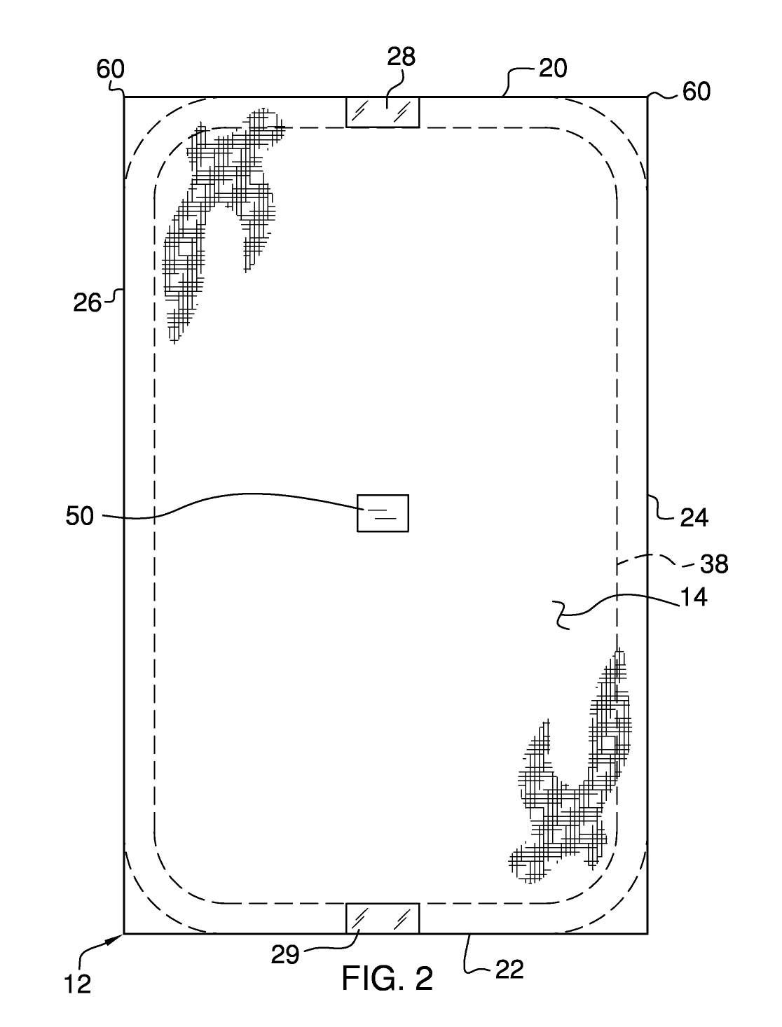

As best illustrated in FIGS. 1 through 6, the vehicle covering and warming system 10 generally comprises a panel 12 that is flexible and has a top side 14, a bottom side 16 and a perimeter edge 18. The perimeter edge 18 includes a first end edge 20, a second end edge 22, a first lateral edge 24 and a second lateral edge 26. The panel 12 includes a transparent section 28 positioned adjacent to the first end edge 20 and positioned between the first 24 and second 26 lateral edges. The transparent section 28 is configured to be aligned with a license plate of a vehicle 70 such that the license plate if viewable through the panel 12. As can be seen in FIG. 2, a pair of transparent sections 28, 29 may be provided. The panel 12 may comprise a plurality of layers including a top layer 30 including the top side 14, a bottom lawyer 32 including the bottom side 16 and a middle layer 34 positioned between the top 30 and bottom 32 layers. The bottom layer 32 comprises a non abrasive cloth material, the middle layer 34 comprises a resiliently compressible material and the top layer 30 comprises a fluid resistant material. The fluid resistant material may include a leather material, synthetic leather material, plastic or elastomeric material. The layers may be removable from each other and in particular the bottom layer 32 may be removable from the other layers 30, 34 so that the bottom layer 32 may be used by itself. The bottom layer 32 may be attached to the middle layer 34 by a zipper 36 or other conventional fastening means including snaps, hook and loop fasteners, buttons and the like. A perimeter band 38 of an elastomeric material may be attached to the bottom side and be adjacent to and coextensive with the perimeter edge.

A heating element 40 is positioned within the panel 12 between the top 14 and bottom 16 sides. The heating element 40 warms the panel 12 to a temperature at least above 32° F. (0° C.) when the heating element 40 is powered. The heating element 40 may be positioned between the top 30 and middle 34 layers to ensure that the top layer 30 is heated such that any accumulated snow or ice melts when the heating element 40 is powered. A power supply 42 is electrically coupled to the heating element 40. The power supply 42 may comprise a power cord 44 which is pluggable into an electrical outlet or the power supply 42 may included one or more batteries. A control 46 is in communication with the heating element 40 to wirelessly and remotely turn the heating element 40 on or off. The control 46 includes a switch 48 that is electrically coupled to the heating element 40. A receiver 50 is electrically coupled to the switch 48 and receives a wireless signal to turn the switch 48 to an on position or an off position. An actuator 52 includes a transmitter 54 that transmits the wireless signal when the transmitter 54 is actuated. The actuator 52 may be provided in a key fob or other housing, which includes on or more buttons 56 for the actuator 52, the transmitter 54 and a battery 58. The transmitter 54 and receiver 50 may be configured for radio wave transmission or infrared light signal transmission.

The panel 12 has four corners 60. A plurality of straps 62 is attached to the panel 12 and each of the corners 60 has one of the straps 62 positioned adjacent thereto. Each of the straps 62 has a pair of ends 64 attached to the bottom side 16 of the panel 12. Each of the straps 62 comprises a magnetic material which may be provided one or magnets 66 positioned within the straps for magnetic adherence to the vehicle 70. The straps 64 may be comprised of a resiliently elastic material for pulling the panel 12 tight on a vehicle 70.

In use, the panel 12 is placed on a vehicle 70 such as a car or small truck and secured in placed with the straps 62. If ice or snow accumulates on the panel, the user will turn the heating element 40 on to melt the snow or ice from the panel 12. The panel 12 is then removed from the vehicle 70 so that it can be driven. The bottom layer 32 protects the vehicle 70 finish while the middle layer 34 offers protection from impacts to the vehicle 70.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle protecting and warming assembly to melt snow and ice off of a vehicle, said assembly comprising:
a panel being flexible and having a top side, a bottom side and a perimeter edge, said perimeter edge including a first end edge, a second end edge, a first lateral edge and a second lateral edge;
a heating element being positioned within said panel between said top and bottom sides, said heating element warming said panel when said heating element is powered;
a power supply being electrically coupled to said heating element;
a control being in communication with said heating element to remotely and wirelessly turn said heating element on or off; and
said panel having four corners, a plurality of straps being attached to said panel, each of said corners having one of said straps positioned adjacent thereto, each of said straps comprising a magnetic material.

2. The vehicle protecting and warming assembly according to claim 1, wherein said panel includes a transparent section positioned adjacent to said first end edge and positioned between said first and second lateral edges, said transparent section being configured to be aligned with a license plate of a vehicle such that the license plate if viewable through said panel.

3. The vehicle protecting and warming assembly according to claim 1, wherein said control includes a switch being electrically coupled to said heating element, a receiver being electrically coupled to said switch, said receiver receiving a wireless signal to turn said switch to an on position or an off position, an actuator including a transmitter transmits the wireless signal when said transmitter is actuated.

4. The vehicle protecting and warming assembly according to claim 1, wherein said panel includes a top layer including said top side, a bottom lawyer including said bottom side and a middle layer positioned between said top and bottom layers, said bottom layer comprising a non abrasive cloth material, said middle comprising a resiliently compressible material, said top layer comprising a fluid resistant material.

5. A vehicle protecting and warming assembly to melt snow and ice off of a vehicle, said assembly comprising:
a panel being flexible and having a top side, a bottom side and a perimeter edge, said perimeter edge including a first end edge, a second end edge, a first lateral edge and a second lateral edge, said panel including a transparent section positioned adjacent to said first end edge and positioned between said first and second lateral edges, said transparent section being configured to be aligned with a license plate of a vehicle such that the license plate if viewable through said panel;
a heating element being positioned within said panel between said top and bottom sides, said heating element warming said panel when said heating element is powered;
a power supply being electrically coupled to said heating element;
a control being in communication with said heating element to turn said heating element on or off, said control including a switch being electrically coupled to said heating element, a receiver being electrically coupled to said switch, said receiver receiving a wireless signal to turn said switch to an on position or an off position, an actuator including a transmitter transmits the wireless signal when said transmitter is actuated;
said panel including a top layer including said top side, a bottom lawyer including said bottom side and a middle layer positioned between said top and bottom layers, said bottom layer comprising a non abrasive cloth material, said middle comprising a resiliently compressible material, said top layer comprising a fluid resistant material; and
said panel having four corners, a plurality of straps being attached to said panel, each of said corners having one of said straps positioned adjacent thereto, each of said straps comprising a magnetic material.
